(19) United States
(12) Patent Application Publication
(10) Pub. No.: US 2016/0087862 A1
(43) Pub. Date: Mar. 24, 2016

(54) IDENTIFYING AND TRANSMITTING PERFORMANCE INFORMATION

(71) Applicant: Microsoft Corporation, Redmond, WA (US)

(72) Inventors: Chandan Kapoor, Redmond, WA (US); Sushanth Dabbiru, Seattle, WA (US); Maya Odunghat, Redmond, WA (US); William James Griffin, Sammamish, WA (US); Sorina Elena Rat, Bothell, WA (US); Benjamin Black, Redmond, WA (US); Alex Bulankou, Redmond, WA (US); Rajesh Maskara, Redmond, WA (US)

(21) Appl. No.: 14/495,171

(22) Filed: Sep. 24, 2014

(51) Int. Cl. H04L 12/26; H04L 29/06; H04L 29/08

(52) U.S. Cl. CPC H04L 43/065; H04L 67/02; H04L 67/42

(57) ABSTRACT

Performance information is gathered on a client, and indicates the performance of a hosted service with respect to the client. A cross origin resource sharing system shares the performance information with an analysis system, that is separate from the hosting service.

### BACKGROUND

Computer systems are currently in wide use. Some systems collect performance information corresponding to the performance of other systems, and log that information or perform various types of analyses on that information.

By way of example, some services are hosted at a remote server environment. The services can host applications that are accessed by client devices that are used by users. In some such systems, attempts have been made to gather performance information that indicates not only how the users are using a given service, but how the service is performing for those users. Often, the server at the hosting service attempts to gather this information, itself.

The discussion above is merely provided for general background information and is not intended to be used as an aid in determining the scope of the claimed subject matter.

### SUMMARY

Performance information is gathered on a client, and indicates the performance of a hosted service with respect to the client. A cross origin resource sharing system shares the performance information with an analysis system, that is separate from the hosting service.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a performance information sharing architecture.

FIG. 2 is a block diagram showing one example of a performance information gathering and communication system (shown in FIG. 1) in more detail.

FIGS. 3A and 3B (collectively referred to herein as FIG. 3) show a flow diagram illustrating one example of the operation of the performance information gathering and communication system shown in FIG. 2.

FIG. 4 is a flow diagram illustrating one example of the operation of a performance information communication system (shown in FIG. 1) in receiving performance information from a client.

FIG. 5 is a block diagram of one example of the architecture shown in FIG. 1, deployed in a cloud computing architecture.

FIGS. 6-8 show various examples of mobile devices that can be used in the architecture shown in FIG. 1.

FIG. 9 is a block diagram of one example of a computing environment that can be used in the architectures of FIGS. 1 and 5.

### DETAILED DESCRIPTION

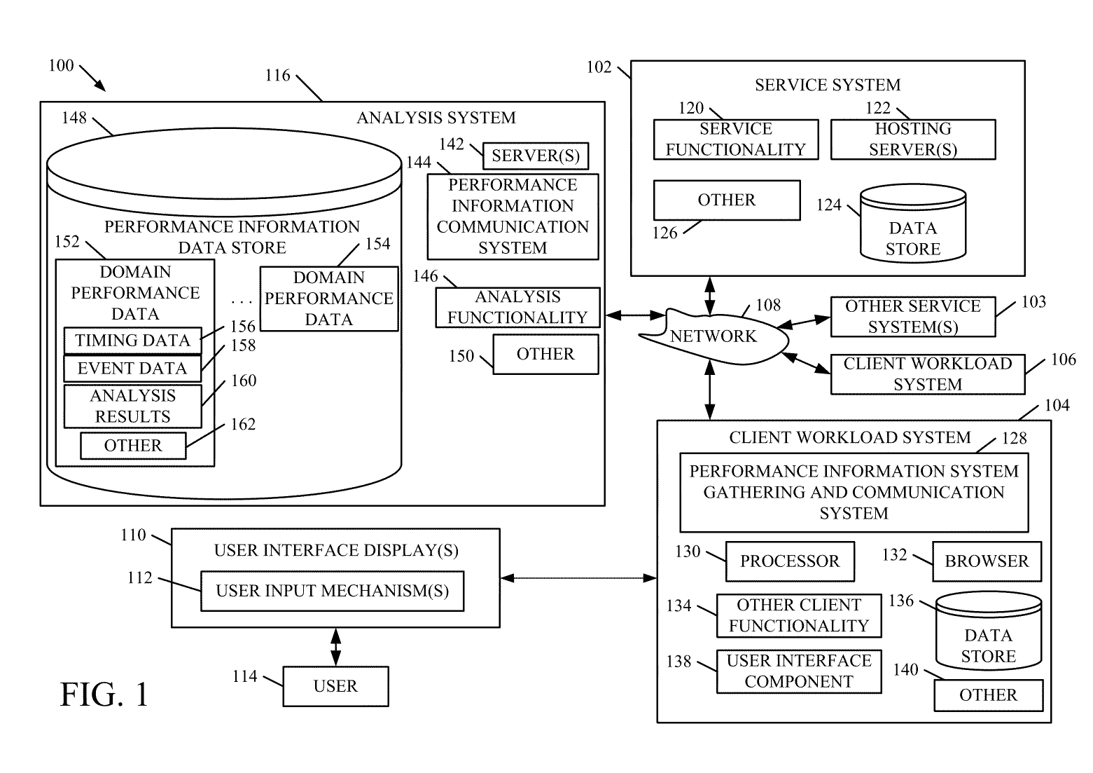

FIG. 1 is a block diagram of one example of a performance information sharing architecture 100. FIG. 1 shows that architecture 100 illustratively includes service systems 102-103 which host services that are accessed by client workload systems 104-106, illustratively over network 108, Systems 102-103 can operate in a similar way or in different ways and they can reside in different domains. Network 108 can be a wide area network, a local area network, etc. Client workload system 104 illustratively generates user interface displays 110 with user input mechanisms 112 for interaction by user 114. User 114 illustratively actuates user input mechanisms 112 to interact with, and control, client workload system 104, in interacting with the hosted service on service systems 102-103. Other client workload systems (e.g., system 106) can operate in a similar fashion.

FIG. 1 also shows that architecture 100 illustratively includes analysis system 116. Analysis system 116 can reside in still a different domain from systems 102-103. It illustratively obtains performance information from client workload systems 104-106, that can be indicative of a performance of service system 102 in hosting the hosted services. It can also be indicative of client interactions with the hosted services, performance of the different client systems 104-106 and other information.

While systems 102-103 can have similar or different operation, one example of the operation of system 102 will be provided, but it is provided for the sake of example only. The example shown in FIG. 1 illustrates that service system 102 illustratively includes service functionality 120, one or more hosting servers 122, a service data store 124, and it can include other items 126. Service functionality illustratively operates on applications or services that are run by hosting servers 122. It provides various service functionality to users 114 so that users 114 can use the hosted service.

Each of the client workload systems 104-106 illustratively include performance information gathering and communication system 128, one or more processors or servers 130, browser 132, other client functionality 134, client data store 136, user interface component 138 and they can include other items 140 as well. User 114 illustratively uses browser 132 to access the hosted service at service system 102. User interface component 138 illustratively generates (either on its own or under control of another item) user interface displays 110. Client data store 136 can be local to system 104, or remotely accessible by system 104. It illustratively stores data that is used by client work load system 104.

Before providing a detailed description of how architecture 100 operates, a brief overview will first be provided. Performance information gathering and communication system 128 illustratively gathers a variety of different performance information (which can include a wide variety of different types of performance metrics, among other information, as well as user interaction information indicative of how user 114 interacts with the hosted service, among other information). It illustratively generates a request using cross origin resource sharing and formats the performance information according to name-value pairs (such as using a javascript object notation—JSON—formatter or another name-value pair formatter) and sends the information to analysis system 116. Other client functionality 134 can provide a wide variety of other types of functionality that is available from client work load system 104.

Analysis system 116 illustratively includes one or more servers or processors 142, performance information communication system 144, analysis functionality 146, performance information data store 148, and it can include other items 150 as well. Performance information data store 148 illustratively stores different sets of domain performance data 152-154 which represents the performance corresponding to different domains (e.g., where different service systems 102-103 reside in different web domains). Each set of different performance data 152 can include a wide variety of different types of performance data, such as timing data 156, event data 158, analysis results 160, or other information 162.

Performance information communication system 144 illustratively receives the performance information using a cross origin resource sharing system, from client work load systems 104-106. It uses a name-value pair parser (such as a JSON format parser) to parse the data and it provides it to analysis functionality 146 for any further analysis. Functionality 146 can include a wide variety of different types of analysis functionality, such as aggregation, transformation, calculation or other functionality. It generates analysis results 160 which can be stored in data store 148 for later use, or transmitted to other systems.

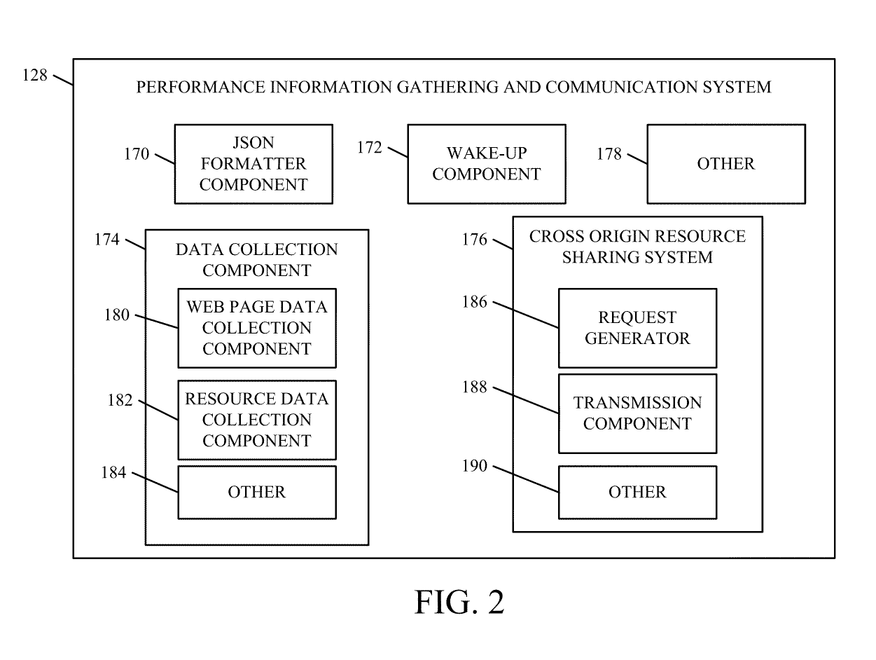

FIG. 2 is a block diagram of one example of performance information gathering and communication system 128, in more detail. In the example shown in FIG. 2, system 128 illustratively includes a name-value pair formatter component (such as JSON formatter component) 170. It also illustratively includes wakeup component 172, data collection component 174, cross origin resource sharing system (CORS system) 176, and it can include other information 178. FIG. 2 shows that, in one example, data collection component 174 illustratively includes web page data collection component 180, that collects web page information. It also illustratively includes resource data collection component 182 that collects performance information regarding loaded resources. It can include a wide variety of other items 184 as well.

Wake up component 172 illustratively wakes up performance information gathering and communication system 128 intermittently. It can wake up system 128 periodically, or after other intermittent intervals. This is described in greater detail below.

CORS is a mechanism that normally allows many resources on a web page to be requested from a domain outside of the domain that the resource originated from. Such resources can include, for instance, fonts, scripts, etc. Web browsers often implement a same origin security policy which inhibits them from sending information across different domains. However, CORS defines a way in which the browser and server can interact to determine whether to allow cross-origin requests. Specific headers are added to payload information. Headers allow servers to serve resources to permitted origin domains. Browsers support the headers so that the payload information can be sent cross-domain.

CORS system 176 illustratively includes request generator 186 that generates a request that is sent to analysis system 116, indicating that system 176 has performance information that it wishes to send to analysis system 116. It can include transmission component 188 that transmits the performance information to analysis system 116, in response to receiving authorization from system 116. System 176 can include other items 190 as well.

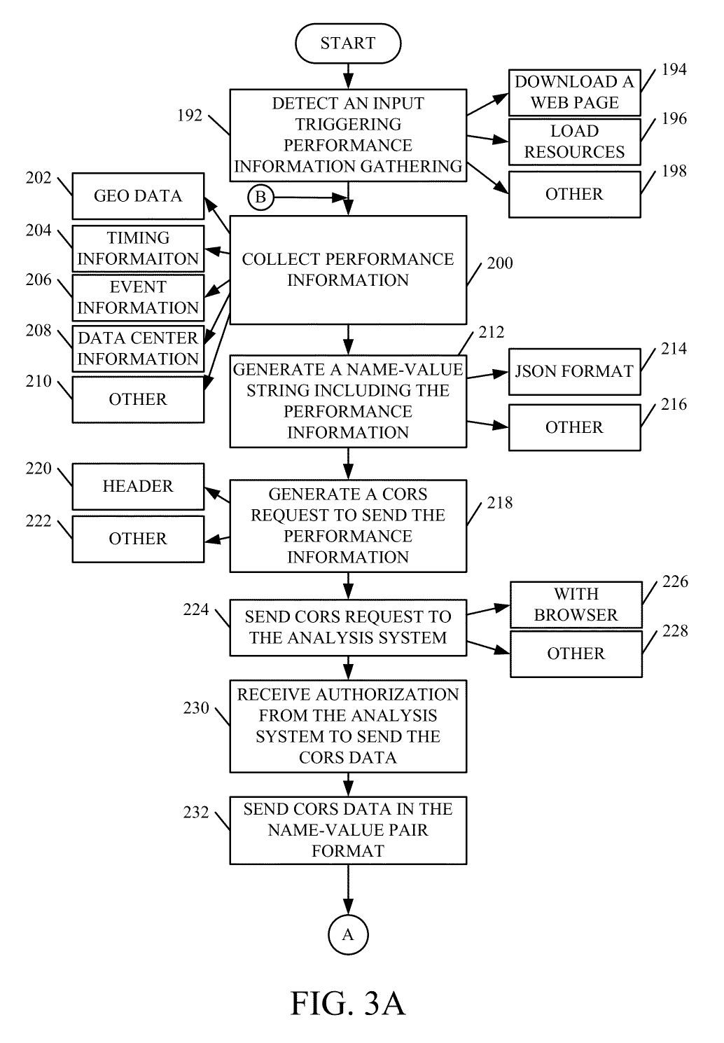

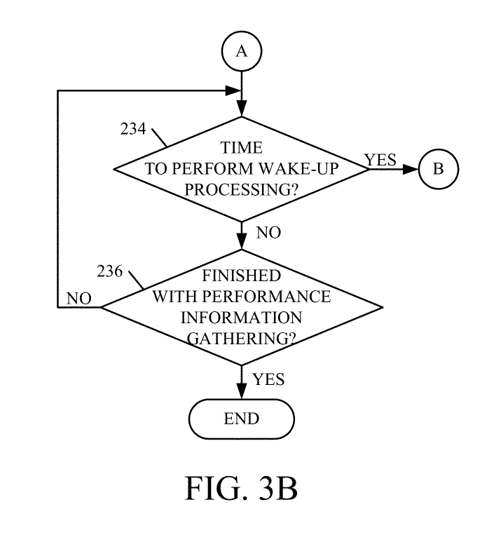

FIGS. 3A and 3B (collectively referred to herein as FIG. 3) show a flow diagram illustrating one example of the operation of performance information gathering and communication system 128 in gathering performance information and transmitting it to analysis system 116. FIGS. 1-3 will now be described in conjunction with one another.

It is first assumed that user 114 has launched browser 132 and is using client workload system 104 to access a hosted service at a service system 102-103 (e.g., service system 102) over network 108. Wake up component 172 in system 128 detects an input triggering performance of the information gathering operations. This is indicated by block 192. The particular input that is detected can vary based upon the different types of performance information that are gathered and transmitted for analysis. For instance, the performance information may be information indicating that a user has downloaded a web page from service 102. It may also include timing information, such as the page load time, the offset between the user request and the time that the page was displayed, among other things.

For instance, user 114 may access a log in page on service system 102 in order to login to a given service. This may cause service system 102 to download the login page. Thus, the performance information may include an item of information indicating that the user has requested to download the login page, along with timing information corresponding to how long it took to download and then display the login page for interaction by the user. Of course, this is only one example of an input that may trigger the performance information gathering process. Where the input is downloading a web page, this is indicated by block 194 in FIG. 3. Where the input is to load resources, this is indicated by block 196. The input could be a wide variety of other inputs 198 as well, such as an elapsed time counter, or others, depending on the type of service, the type of performance information being gathered, etc.

Data collection component 174 then collects the performance information. This is indicated by block 200. For instance, it can collect geographical data 202, timing information 204, event information 206, data center information 208 (indicative of a particular data center that user 114 is accessing) or a wide variety of other performance information 210.

Formatter component 170 then generates a name-value pair string that includes the gathered performance information. This is indicated by block 212. For instance, in one example, formatter 170 can generate the string according to the JSON format. This is indicated by block 214. Of course, it can generate this string using a wide variety of other formats 216.

Request generator 186 in CORS system 176 (shown in FIG. 2) then generates a CORS request to send the performance information to analysis system 116. In doing so, and in one example, request generator 186 illustratively generates one or more specific CORS headers indicating that payload information is to be sent cross-domain. Generating a CORS request to send the performance information is indicated by block 218, and generating the one or more headers is indicated by block 220. Of course, the CORS request can be generated in other ways as well, and this is indicated by block 222.

Browser 132 then sends the CORS request to analysis system 116. This is indicated by block 224. Sending the request with the browser is indicated by block 226, and sending it other ways is indicated by block 228.

Performance information communication system 144 at analysis system 116 illustratively processes the headers and, if authentic, sends authorization to system 128 to send the performance information. Receiving authorization information from analysis system 116 is indicated by block 230 in FIG. 3.

Transmission component 188 then sends the CORS data in the name-value pair format. This is indicated by block 232. For instance, it can send the CORS data (the gathered performance information) in the JSON format.

At any point during the process, wake up component 172 can wake up data collection component 174 to again initiate the data gathering process, in order to gather new performance information. This is indicated by block 234. When this occurs, processing reverts to block 200. For instance, it may be that system 176 sends information initially upon opening a web page. After the web page is loaded, it may be that new resources are available to send their corresponding timing information. Therefore, wake up component 172 intermittently wakes up component 174 to look for new performance information that is to be sent.

At some point, the system will be finished performing operations of gathering and sending performance data. This is indicated by block 236.

It should also be noted that, in other examples, the performance information can be sent in other ways. For instance, the collected information, that is formatted using formatter component 170, can be sent along with the headers that are created when generating the CORS request. Therefore, instead of sending the request and the payload separately, all of the information can be incorporated into the headers for the request. The information can be transmitted in other ways as well.

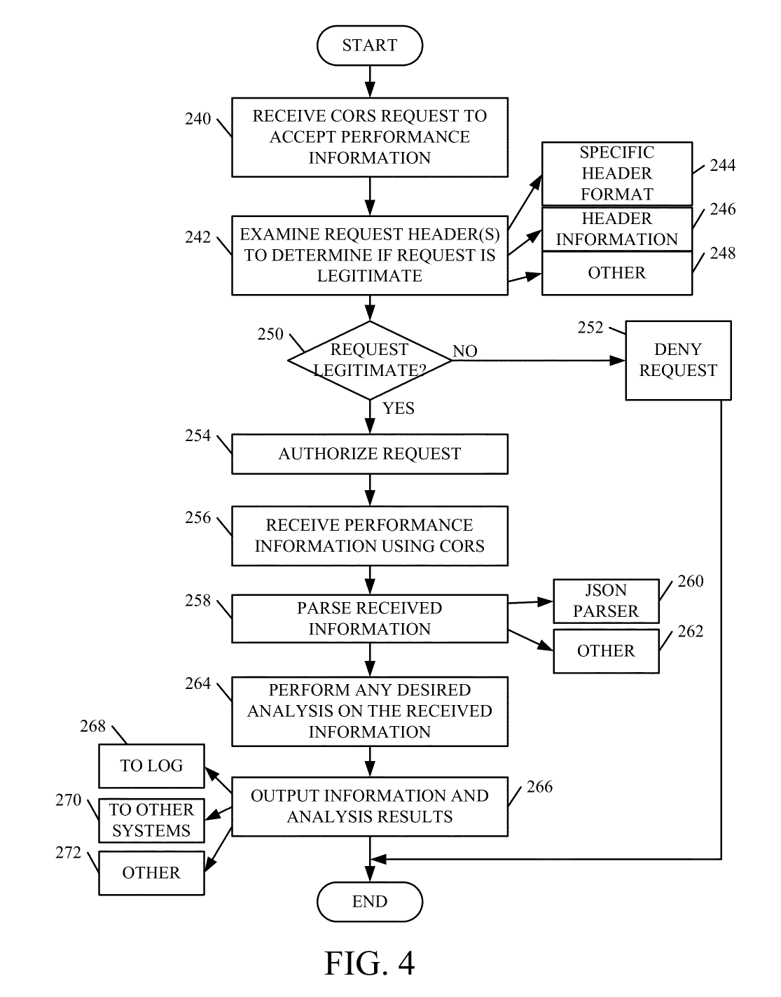

FIG. 4 is a flow diagram illustrating one example of the operation of performance information communication system 144, in analysis system 116, in obtaining the performance information from a client workload system 104. System 144 first receives the CORS request from system 104. This is indicated by block 240 in FIG. 4. System 144 then examines the request headers to determine whether the request is a legitimate request. This is indicated by block 242. For instance, it can examine the specific header format 244, or the content of the specific header information 246. It can also determine whether the request is authentic in other ways 248 as well.

Based upon its examination of the request header, system 144 determines whether the request is legitimate. This is indicated by block 250. If not, the request is simply denied and a corresponding message is returned to client workload system 104. Denying the request is indicated by block 252.

If the request is legitimate, then system 144 authorizes the request. This is indicated by block 244. This indicates to client workload system 104 that it can send the CORS payload information which includes the performance information. Receiving the performance information using CORS communication is indicated by block 256. Again, as briefly described above, the performance information can also be embedded into the CORS headers. Thus, if system 144 determines that the request is legitimate, it can simply obtain the information from the headers. However, in another example, it can authorize system 104 to send the performance information separately.

Once the performance information is received, it is illustratively received in a name-value pair format. Therefore, system 114 parses the received information. This is indicated by block 258. It can do this using a JSON parser 260, or using other parsers 262.

System 144 then sends the parsed information to analysis functionality 146 where any desired analysis operations can be performed on the information. Of course, there is a wide variety of different types of analysis that can be performed on the information. Performing any desired analysis operations on the received information is indicated by block 264.

The performance information (along with any analysis results) is output for use in other systems. This is indicated by block 266. For instance, it can be output to performance information data store 148 where it is logged as a set of domain performance data 152-154. This is indicated by block 268. It can be output to other analysis systems or other systems as well, and this is indicated by block 270. It can be output for still other reasons, and this is indicated by block 272.

It can thus be seen that the present description provides significant technical advantages. It allows a single analysis system to log performance information (such as timing and event data, or other data) for different domains. This not only allows the single analysis system to obtain the performance information more quickly and directly from the systems that gather the information, but it also improves the performance of the hosting services. For instance, if the performance information were sent back to the hosting services, this would undesirably increase the workload on the hosting services. Instead, by allowing the information to be sent cross-domain, to a separate analysis system, the hosting service has more performance overhead to devote to the actual hosting of services. In addition, the performance information is sent in a name-value pair format (such as the JSON format). This enables the receiving system to parse the performance information relatively quickly. Further, new performance metrics can be introduced on both the client and the analysis system, in a relatively straightforward manner, using the name-value pair format. This approach also allows the analysis system to quickly and easily log geographical information which can indicate a particular service center that the client is using, among other things. In addition, the system can intermittently wakeup to determine whether additional performance information, such as information for newly loaded resources, is available for sending.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

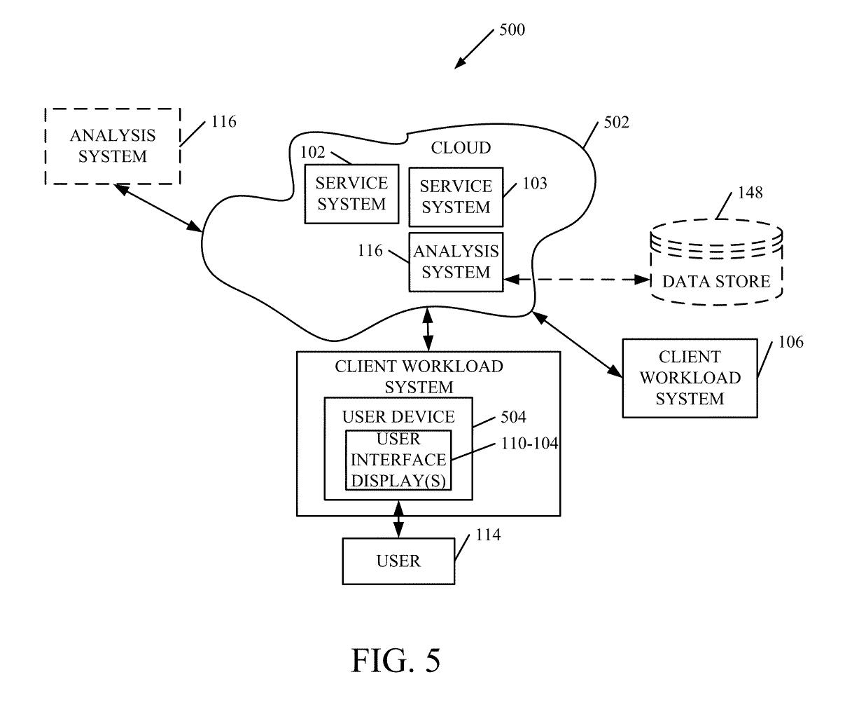

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that service systems 102-103 and analysis system 116 can be located in cloud 502 (which can be public, private, or a combination where portions are public while others are private). Therefore, user 114 uses a user device 504 in client workload system 104 to access those systems through cloud 502.

FIG. 5 also depicts another example of a cloud architecture. FIG. 5 shows that it is also contemplated that some elements of architecture 100 are disposed in cloud 502 while others are not. By way of example, data store 148 can be disposed outside of cloud 502, and accessed through cloud 502. In another example analysis system 116 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

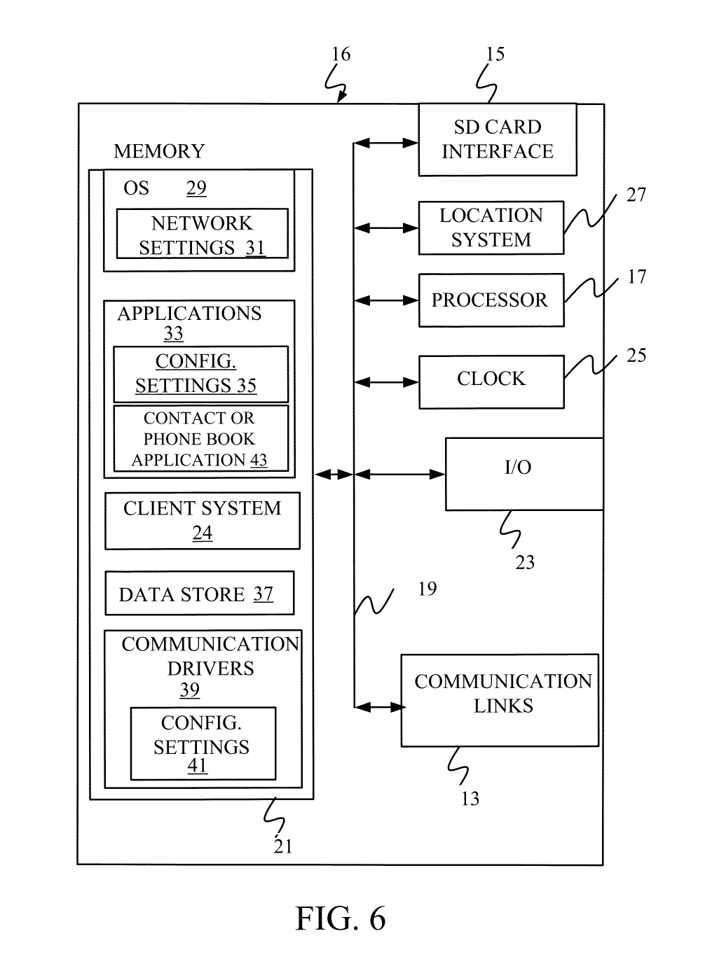

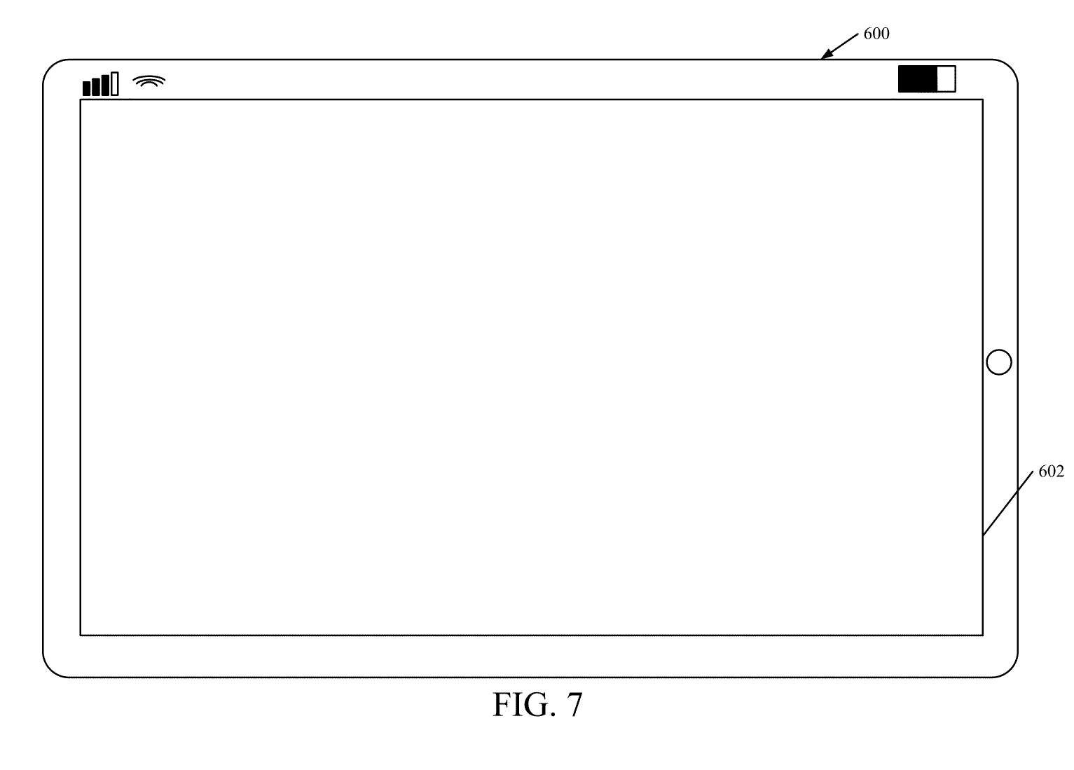

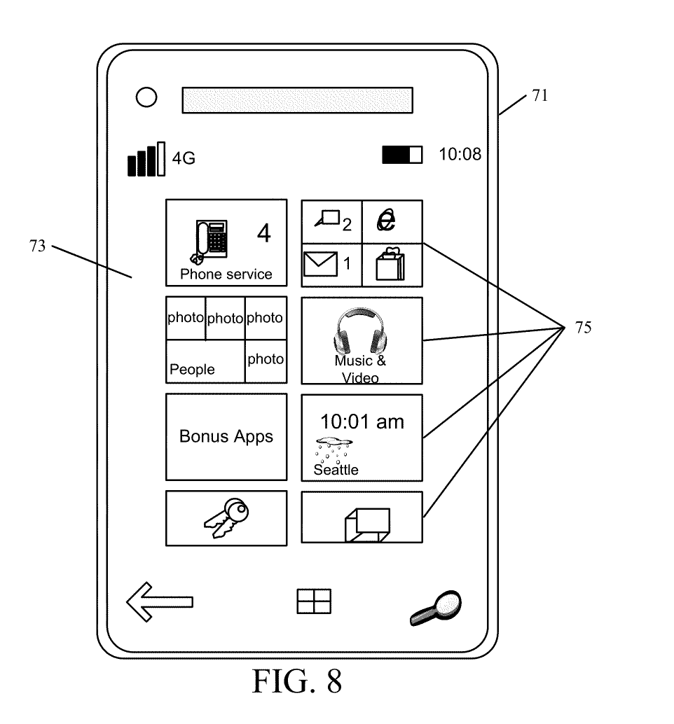

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of client system 104 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

Under other example, applications or systems are received on a removable Secure Digital (SD) card that is connected to a SD card interface 15. SD card interface 15 and communication links 13 communicate with a processor 17 (which can also embody processors 122, 130 or 142 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various business applications or embody parts or all of client system 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of device 16 can also be used. For instance, device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples the phone also includes a Secure Digital (SD) card slot that accepts a SD card.

The mobile device can also be a personal digital assistant (PDA) or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. Although not shown, the PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 8 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

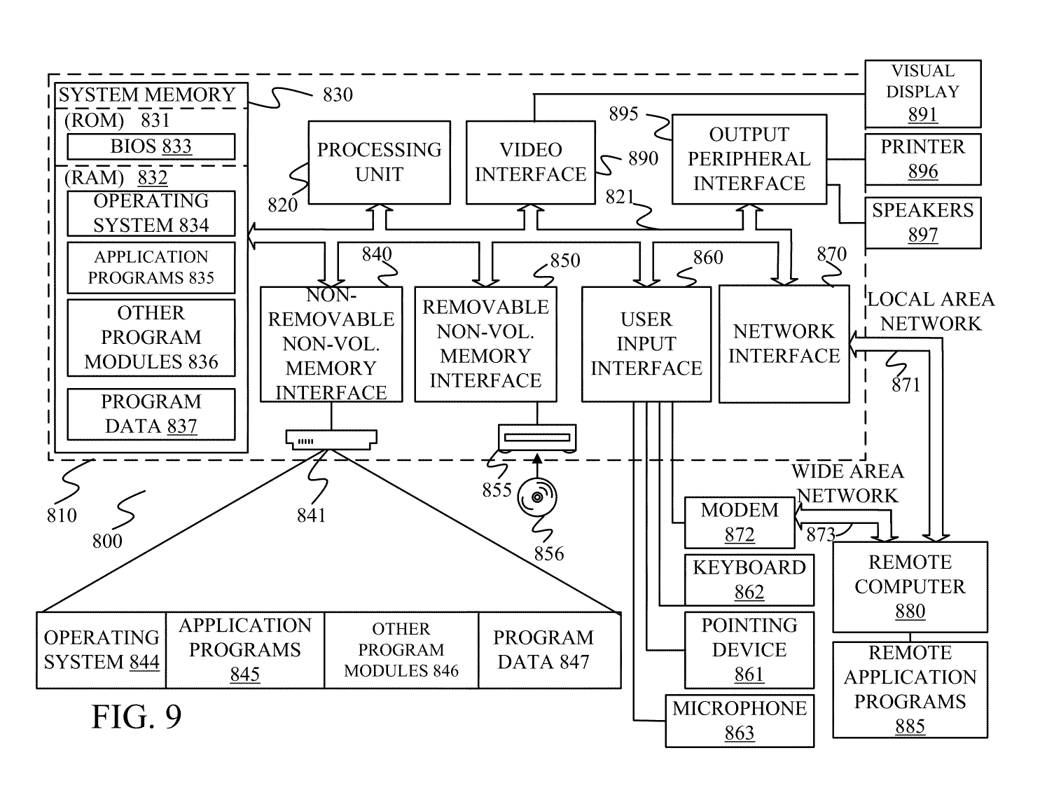

FIG. 9 is one example of a computing environment in which architecture 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processors or servers 122, 130 or 142), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a browser;

a data collection component configured to collect performance information indicative of a performance of a hosted service, in a first domain, with respect to a client device; and

a sharing system configured to send the performance information to a system that is in a second domain, different from the first domain, using the browser.

Example 2 is the computing system of any and all previous examples wherein the sharing system comprises a cross origin resource sharing system.

Example 3 is the computing system of any and all previous examples and further comprising:

a formatter component configured to receive the performance information and format it according to a name-value pair format, before the sharing system sends the performance information.

Example 4 is the computing system of any and all previous examples wherein the formatter component formats the performance information into the name-value pair format that has a name of an item of performance information paired with a value of the item of performance information.

Example 5 is the computing system of any and all previous examples wherein the cross origin resource sharing system comprises:

a request generator configured to generate a request and send the request to the system in the second domain.

Example 6 is the computing system of any and all previous examples wherein the cross origin resource sharing system comprises:

a communication component configured to receive authorization from the second system in the second domain and transmit the performance information in response to receiving authorization.

Example 7 is the computing system of any and all previous examples wherein the request generator generates a request header, including the performance information, and sends the request header to the system in the second domain as part of the request.

Example 8 is the computing system of any and all previous examples and further comprising:

a wake-up component configured to detect an input triggering the data collection component to collect the performance information.

Example 9 is the computing system of any and all previous examples wherein the wake-up component intermittently triggers the data collection component to determine whether any new performance information is available for sending to the system in the second domain.

Example 10 is the computing system of any and all previous examples wherein the data collection component collects web page performance information indicative of performance relative to a web page, and resource information indicative of performance information corresponding to a set of resources.

Example 11 is a method, comprising:

collecting performance information on a client system, indicative of a performance of a hosted service, in a first domain, with respect to the client device; and

sending the performance information to a system that is in a second domain, different from the first domain, using a browser on the client system.

Example 12 is the method of any and all previous examples and further comprising:

formatting the performance information according to a name-value pair format, before sending the performance information.

Example 13 is the method of any and all previous examples wherein sending the performance information comprises:

sending a request to the system in the second domain.

Example 14 is the method of any and all previous examples wherein sending the performance information comprises:

receiving authorization from the second system in the second domain; and

in response, transmitting the performance information to the system in the second domain.

Example 15 is the method of claim 14 wherein sending a request comprises:

generating a request header, including the performance information; and

sending the request header to the system in the second domain as part of the request.

Example 16 is the method of any and all previous examples and further comprising:

intermittently determining whether any new performance information is available for sending to the system in the second domain.

Example 17 is the method of any and all previous examples wherein collecting performance information comprises:

collecting web page performance information indicative of performance corresponding to a web page; and

collecting resource information indicative of performance information corresponding to a set of resources.

Example 18 is a computer readable storage medium that stores computer executable instructions which, when executed by a computer, cause the computer to perform a method, comprising:

receiving, from a client system, at an analysis system residing in a first domain, performance information corresponding to performance of a hosted system residing in a second domain;

performing analysis on the performance information to obtain analysis results; and

storing the performance information and analysis results.

Example 19 is the computer readable storage medium of any and all previous examples wherein receiving comprises:

receiving, from a plurality of different client systems, performance information corresponding to performance of a plurality of hosted systems in a plurality of different domains.

Example 20 is the computer readable storage system of any and all previous examples wherein receiving comprises:

receiving the performance information using a cross origin sharing system that receives the performance information in a name-value pair format.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a browser;
a data collection component configured to collect performance information indicative of a performance of a hosted service, in a first domain, with respect to a client device; and
a sharing system configured to send the performance information to a system that is in a second domain, different from the first domain, using the browser.

2. The computing system of claim 1 wherein the sharing system comprises a cross origin resource sharing system.

3. The computing system of claim 2 and further comprising:
a formatter component configured to receive the performance information and format it according to a name-value pair format, before the sharing system sends the performance information.

4. The computing system of claim 3 wherein the formatter component formats the performance information into the name-value pair format that has a name of an item of performance information paired with a value of the item of performance information.

5. The computing system of claim 3 wherein the cross origin resource sharing system comprises:
a request generator configured to generate a request and send the request to the system in the second domain.

6. The computing system of claim 5 wherein the cross origin resource sharing system comprises:
a communication component configured to receive authorization from the second system in the second domain and transmit the performance information in response to receiving authorization.

7. The computing system of claim 5 wherein the request generator generates a request header, including the performance information, and sends the request header to the system in the second domain as part of the request.

8. The computing system of claim 3 and further comprising:
a wake-up component configured to detect an input triggering the data collection component to collect the performance information.

9. The computing system of claim 8 wherein the wake-up component intermittently triggers the data collection component to determine whether any new performance information is available for sending to the system in the second domain.

10. The computing system of claim 8 wherein the data collection component collects web page performance information indicative of performance relative to a web page, and resource information indicative of performance information corresponding to a set of resources.

11. A method, comprising:
collecting performance information on a client system, indicative of a performance of a hosted service, in a first domain, with respect to the client device; and
sending the performance information to a system that is in a second domain, different from the first domain, using a browser on the client system.

12. The method of claim 11 and further comprising:
formatting the performance information according to a name-value pair format, before sending the performance information.

13. The method of claim 12 wherein sending the performance information comprises:
sending a request to the system in the second domain.

14. The method of claim 13 wherein sending the performance information comprises:
receiving authorization from the second system in the second domain; and
in response, transmitting the performance information to the system in the second domain.

15. The method of claim 14 wherein sending a request comprises:
generating a request header, including the performance information; and
sending the request header to the system in the second domain as part of the request.

16. The method of claim 15 and further comprising:
intermittently determining whether any new performance information is available for sending to the system in the second domain.

17. The method of claim 11 wherein collecting performance information comprises:
collecting web page performance information indicative of performance corresponding to a web page; and
collecting resource information indicative of performance information corresponding to a set of resources.

18. A computer readable storage medium that stores computer executable instructions which, when executed by a computer, cause the computer to perform a method, comprising:
receiving, from a client system, at an analysis system residing in a first domain, performance information corresponding to performance of a hosted system residing in a second domain;
performing analysis on the performance information to obtain analysis results; and
storing the performance information and analysis results.

19. The computer readable storage medium of claim 18 wherein receiving comprises:
receiving, from a plurality of different client systems, performance information corresponding to performance of a plurality of hosted systems in a plurality of different domains.

20. The computer readable storage system of claim 19 wherein receiving comprises:
receiving the performance information using a cross origin sharing system that receives the performance information in a name-value pair format.
